(19) United States
(12) Patent Application Publication
(10) Pub. No.: US 2019/0014900 A1
(43) Pub. Date: Jan. 17, 2019

(54) MANUAL TOOTH BRUSH WITH TIMER

(71) Applicant: William Battaglia, North Haledon, NJ (US)

(72) Inventor: William Battaglia, North Haledon, NJ (US)

(21) Appl. No.: 15/648,939

(22) Filed: Jul. 13, 2017

(51) Int. Cl. A46B 15/00; A46B 9/04; H01H 29/20; H01H 35/02; G04F 8/00

(52) U.S. Cl. CPC A46B 15/004; A46B 9/04; A46B 15/0046; A46B 2200/1066; H01H 35/02; G04F 8/00; H01H 29/20

(57) ABSTRACT

A manual tooth brush having a timer function. The tooth brush has a body that defines a cavity therein and in which a timer is located. The brush uses an inversion switch instead of an accelerometer to activate the timer. The inversion switch, or tilt switch, may be a mercury type tilt switch or a ball type tilt switch. When the tooth brush is tilted such that the head is below the brush body, the tilt switch is activated and the switch in turn activates the microprocessor. Activating the tilt switch also starts the timer that is linked to the microprocessor. Because the microprocessor is only activated when the tooth brush is tilted, the battery life of the tooth brush is extended. The brush timer is programed to run for about 2 minutes. The tooth brush vibrates or makes a sound every 30 seconds. The timer deactivates after 2.5 minutes.

### TECHNICAL FIELD

Generally, the current disclosure relates to a tooth brush. Specifically, the current disclosure is directed to a manual tooth brush. More particularly, the current disclosure relates to a manual tooth brush having a timer that includes at least one inversion switch to start the timer.

### BACKGROUND INFORMATION

Electric tooth brushes frequently include a timer that enables users to track the amount of time they brush their teeth. The tooth brush vibrates to indicate to the user that a certain amount of time has passed. Manual tooth brushes do not typically include electrical systems and therefore they do not typically include timers. In some instances, a manual tooth brush may be provided with a timer. Generally, these manual tooth brushes use solid state accelerometers to sense a rapid brushing movement to start the timer. The accelerometer is operatively engaged with a microprocessor and in order to start the timer, the microprocessor must be in an on-position. Monitoring the accelerometer action using the microprocessor unnecessarily drains a microprocessor battery. Electrical components such as microprocessors and accelerometers may be complicated and expensive, and may require powerful batteries because these components may consume a lot of energy when the brush is not in use.

### SUMMARY

Therefore, there is a need in the art for an improved manual tooth brush that allows users to track the time they brush their teeth.

The current disclosure relates to a manual tooth brush having a timer function. The tooth brush has a brush body that defines a cavity therein and in which a timer is located. The manual tooth brush is relatively inexpensive and less complicated because it uses an inversion switch instead of an accelerometer to activate the timer. The inversion switch, or tilt switch, may be a mercury type tilt switch or a ball type tilt switch. When the tooth brush is tilted such that the head is below the brush body, the tilt switch is activated and the switch in turn activates the microprocessor. Activating the tilt switch also starts the timer that is linked to the microprocessor. Because the microprocessor is only activated when the tooth brush is tilted, the battery life of the tooth brush is extended. The brush timer is programed to run for about 2 minutes. The tooth brush vibrates or makes a sound every 30 seconds. The timer deactivates after 2.5 minutes.

In one aspect, the current disclosure may provide a manual tooth brush comprising a brush head, a brush body extending from an end of the brush head, a cavity defined by the brush body, and a brush timer, wherein the brush timer is received within the cavity.

In another aspect, the current disclosure may provide a method of tracking brushing time using a manual tooth brush comprising steps of providing a manual tooth brush including a brush timer and a tilt switch, titling the manual tooth brush, activating the tilt switch, activating the brush timer, brushing teeth with the tooth brush, tracking a brushing time, and deactivating the timer at an end of the brushing time.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a top perspective view of a manual tooth brush with a timer in accordance with the present disclosure,

FIG. 2 is a top exploded view of the manual tooth brush of FIG. 1,

FIG. 3 is a top exploded view of the manual tooth brush of FIG. 1 with an electrical assembly thereof in assembled state,

FIG. 4 is a cross section view taken along line 4-4 of FIG. 1,

FIG. 4A is an enlarged view of a tilt switch of FIG. 4,

FIG. 5 is a side elevation view of the manual tooth brush leaning against a wall of a cup,

FIG. 6 is side elevation view of the manual tooth brush lying on a surface, and

FIG. 7 is a side elevation view of the manual tooth brush tilted relative to a horizontal axis to activate the timer.

Similar numbers refer to similar parts throughout the drawings.

### DETAILED DESCRIPTION

The present disclosure relates to a manual tooth brush with a timer installed in the tooth brush so that the brush can provide a predetermined appropriate brushing time to a user.

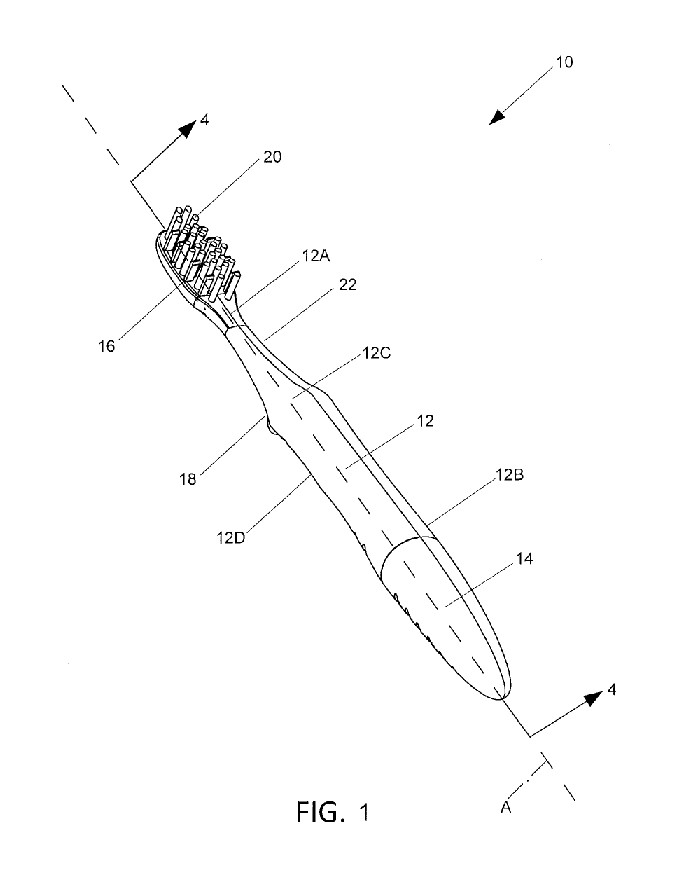

FIG. 1 shows a top perspective view of a manual brush 10. The brush 10 comprises a brush body 12, a screw-off cap 14, and a brush head 16 including a plurality of bristles 20. The brush body 12 may be ergonomically designed to include a brush support 18. The brush body 12 extends from a top end 12A to a bottom end 12B and defines a longitudinal axis “A” that extend from the top end 12A to the bottom end 12B. The brush body 12 has a front surface 12C and a rear surface 12D. The brush body 12 includes a neck section 22 which is tapered towards the top end 12A. The top end 12A of the brush body 12 is connected to the brush head 16. The cap 14 extends from a first end 14A to a second end 14B. As depicted, the cap 14 is tapered as it extends toward the second end 14B. The bottom end 12B of the brush body 12 is operatively connected to the first end 14A of the cap 14.

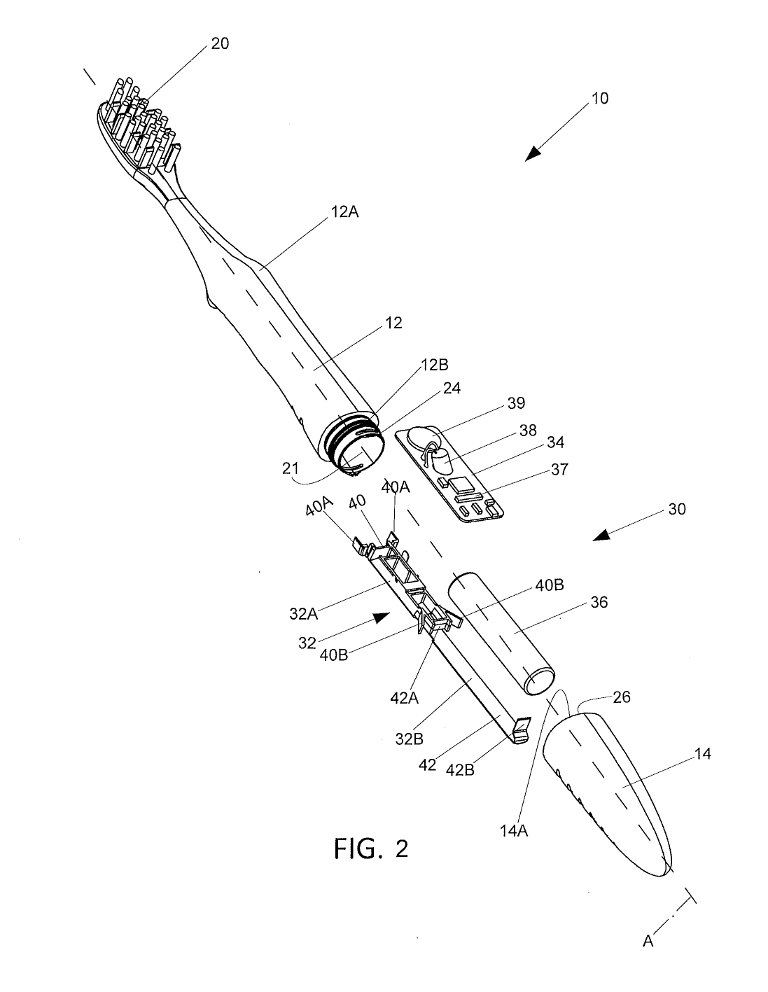

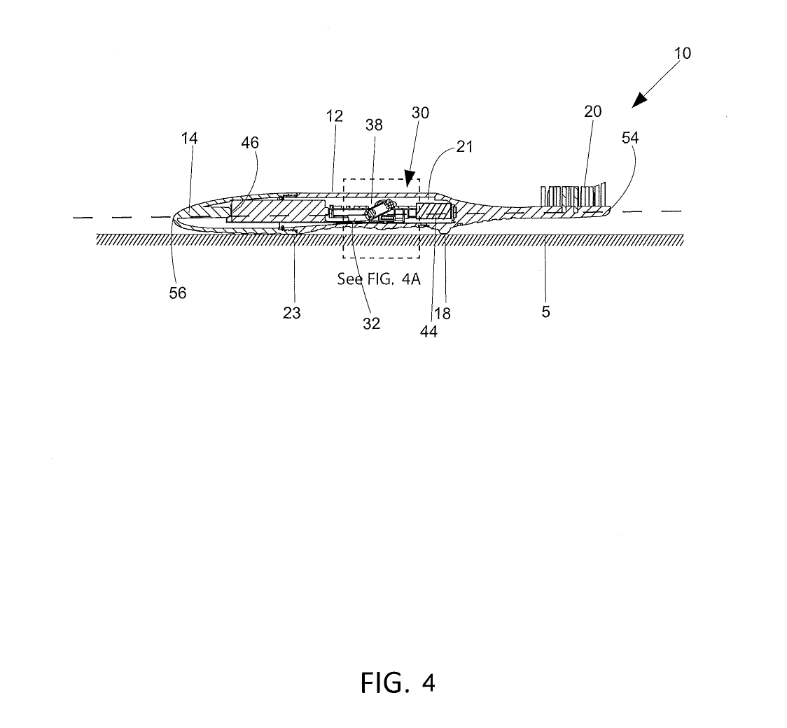

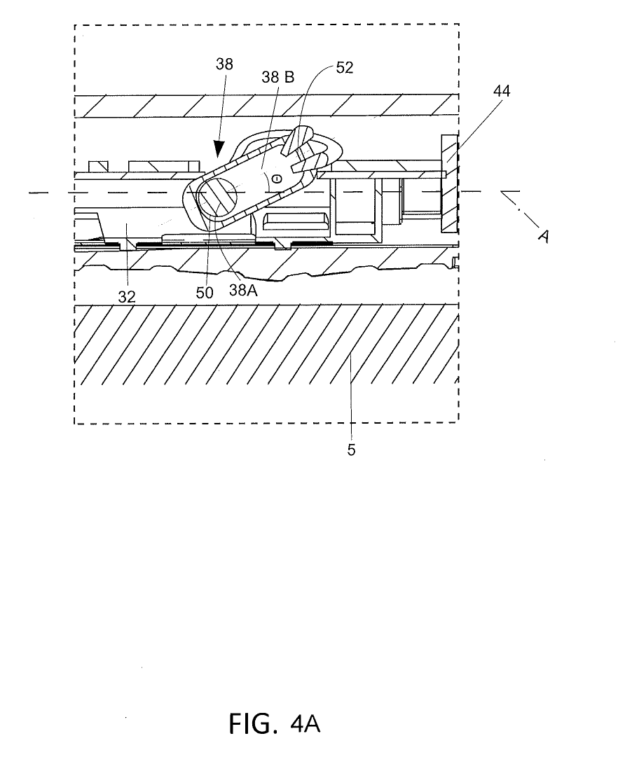

As depicted in FIG. 2, brush body 12 defines a cavity 21 therein and the bottom end 12B of the brush body defines an opening that is in communication with the cavity 21. Bottom end 12B is externally threaded with a thread 24 that is engagable with a complementary internal thread (shown in FIG. 4) provided on the first end 14A of cap 14. The cavity 21 receives an electrical assembly 30 which will be described hereafter.

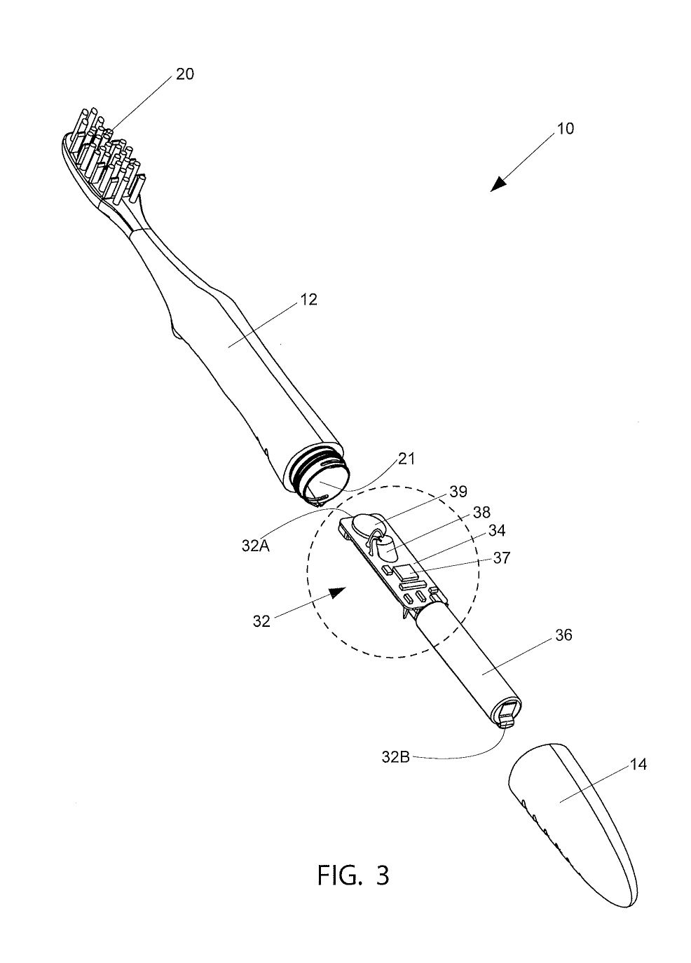

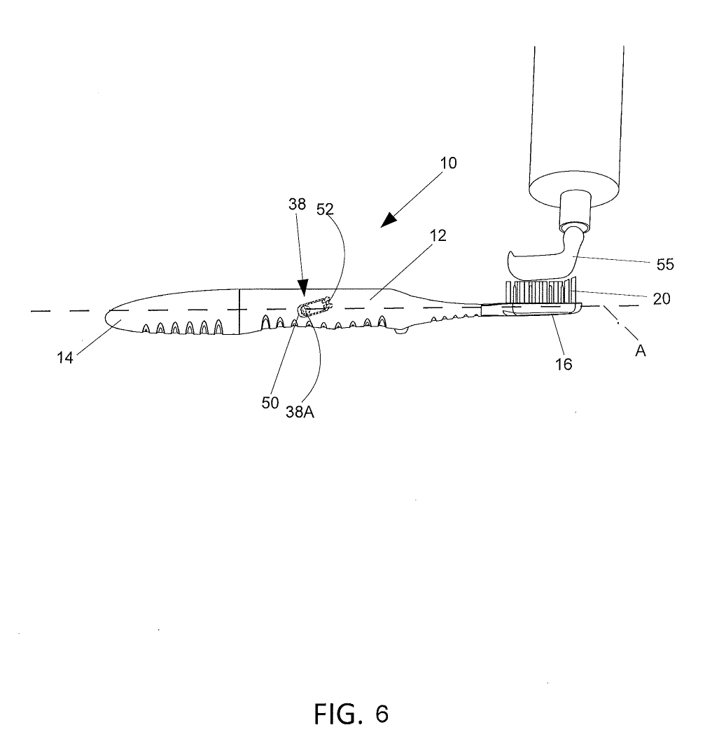

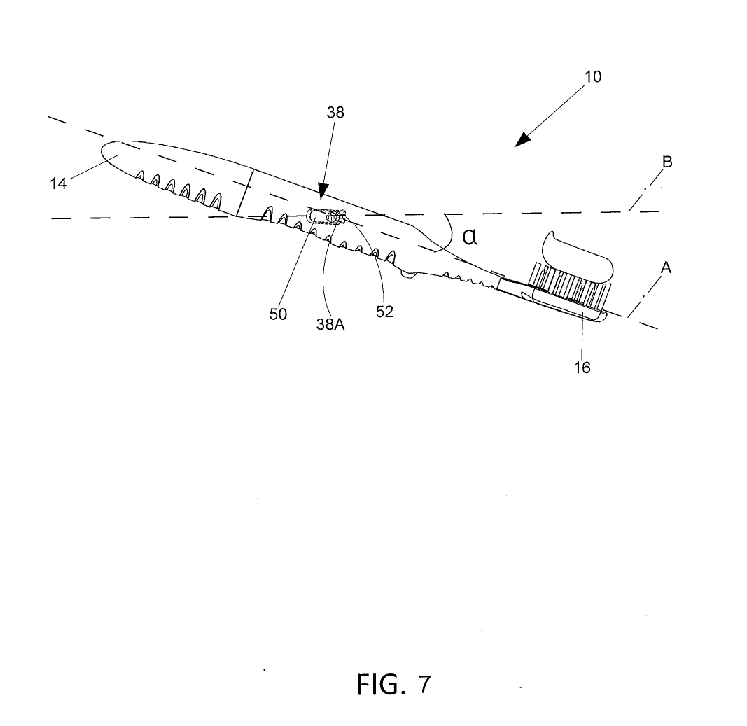

As depicted in FIGS. 2 and 3, the electrical assembly 30 includes a chassis 32, a Printed Circuit Board (PCB) 34, and a battery 36. The PCB 34 includes a microprocessor 37, a ball type tilt switch 38 (or a mercury type tilt switch), and a piezo electric element 39. The microprocessor 37 may include a timer, or a timer may be provided as a separated device on the PCB 34 and be operatively engaged with the microprocessor 37. Tilt switch 38 is operatively engaged with the microprocessor 37 and therefore with the timer. The ball type switch 38 further comprises a ball 38A (shown in FIG. 4A) and a channel 38B. The ball 38A is movable from one end to the channel 38B to the other as the tooth brush 10 is tilted. The ball 38A is therefore movable from a resting position 50 (FIG. 6) to an activating position 52 (FIG. 7).

The chassis 32 comprises an upper portion 32A and a lower portion 32B. The upper portion 32A of the chassis 32 comprises a PCB holding bed 40 that holds the PCB 34. The chassis 32 includes two upper locking arms 40A and two lower locking arms 40B. The locking arms 40A, 40B help to retain the electrical assembly 30 in position within the cavity 21. The PCB 34 has a flat rectangular shape so that it can be bedded on top of the PCB holding bed 40 as shown in FIG. 3. The lower portion 32B of the chassis 32 includes a battery holding bed 42. The bed 42 extends from a top end 42A and a bottom end 42B. The battery 36 is snuggly received between the top end 42A and the bottom end 42B. It will be understood that the power sources other than battery 36 may be utilized in the tooth brush 10.

As depicted in FIG. 4, the electrical assembly 30 is placed inside of the hollow cavity 21 of the brush body 12. The electrical assembly 30 is securely placed between an upper stopper 44 and a lower stopper 46 so that the electrical assembly 30 will not move during brushing. The lower stopped 46 may be provided in the cap 14. The manual brush 10 may be placed on a surface “S” on the first support 18 of the main brush body 12 and a second support 23 located on the cap 14.

As shown in FIG. 4A, the ball switch 38 is positioned on the chassis 32 at an angle θ relative to the axis “A”. The angle θ can be between 0 to 90 degrees with respect to the axis “A”. If the brush 10 is placed on the surface “S”, the axis “A” is horizontal (i.e. parallel to the surface “S”), and the ball 38A is in the resting position 50. When the ball 38A is in the resting position 50, the timer is switched off.

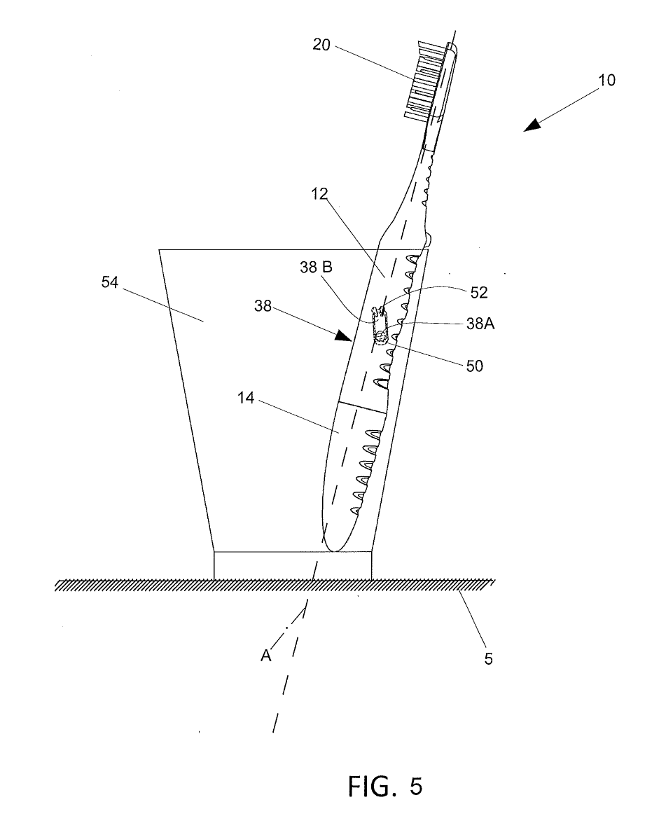

In FIG. 7, a horizontal axis or plane is indicated by reference number “B”. In operation, as shown in FIGS. 4 to 7, initially the manual tooth brush 10 is placed on surface “S” or placed inside of a cup 54 with the brush head 16 facing upwardly or is held in the hand with the brush head 16 facing upwardly. When the brush 10 is in any of these positions, the ball 38A remains in the resting position 50 and the ball switch 38 remains in the off position. This is because the longitudinal axis “A” of the tooth brush 10 is located in an orientation parallel to or greater than the horizontal axis “B”. As shown in FIG. 6, when the user applies a tooth paste 55 to the bristles 20 on the brush head 16, and as long as the user keeps the brush 10 with the longitudinal axis “A” horizontal or greater horizontal, the ball switch 38A is not triggered.

As shown in FIG. 7, when the brush 10 is tilted to an orientation where the head 16 is lower than the cap 14, then the ball switch 38 is triggered. Tilting the brush 10 moves the longitudinal axis “A” through an angle α below the horizontal axis “B”. The ball switch 38 is triggered by the ball 38A moving along the channel 38B from the resting position 50 to the activating position 52. A typical angle α to activate the ball switch 38 is from about 15° up to about 25°. However, in other embodiments, this angle α can be less than 15° or more than 25°, dependent upon types of tilt switches that may be used in the tooth brush 10.

Once the ball switch 38 is activated, the brush timer in the microprocessor 37 is switched on. Programing in the microprocessor 37 includes a predetermined brushing time of about 2 minutes. The programming also includes a predetermined time in which the microprocessor 37 will generate an alarm to keep the user aware of how long they brushed their teeth. For instance, the microprocessor 37 may be set to vibrate a portion of the tooth brush 10 or sound an audible alarm every 30 seconds until the predetermined 2 minutes brushing time is reached. Once the timer reaches the 2 minutes mark, the brush 10 either vibrates or sounds an audible alarm multiple times to notify the user that they may finish brushing their teeth. However, the microprocessor 37 may be programed to automatically switch off the brush timer at a predetermined interval beyond 2 minutes. For example, the microprocessor 37 may be programmed to switch off the brush timer 2.5 minutes after activation.

The ball switch 38 cannot be re-triggered after activation until the 2.5 minutes time period is completed. This is true even if the ball 38A in the ball switch 38 along the channel 38B moves from the resting position 50 to the activating position 52.

It is understood that the ball type switch 38 can be replaced by any type of tilt switch including a mercury type tilt switch. Moreover, it is also understood that the battery 36 may be a AAA battery, a AA battery, or any other batteries as long as it can provide sufficient electrical power to the microprocessor 37, the ball type tilt switch 38, and the round piezo 39 on the PCB 34.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration set out herein are an example and the invention is not limited to the exact details shown or described.

1. A manual tooth brush comprising:
a brush head;
a brush body extending from an end of the brush head;
a cavity defined by the brush body; and
a brush timer, wherein the brush timer is received within the cavity.

2. The manual tooth brush of claim 1, where the brush timer includes a tilt switch.

3. The manual tooth brush of claim 2, wherein the tilt switch is a ball switch.

4. The manual tooth brush of claim 2, wherein the tilt switch is a mercury switch.

5. The manual tooth brush of claim 1, further comprising a chassis received in the cavity, and wherein the tooth brush further comprises a Printed Circuit Board (PCB) engaged with the chassis and programed to operate the brush timer.

6. The manual tooth brush of claim 5, further comprising a power source operatively with the PCB and the brush timer.

7. The manual tooth brush in claim 1, further comprising a vibrating mechanism activatable to vibrate a portion of the tooth brush.

8. The manual tooth brush in claim 1, further comprising a sound generating mechanism.

9. The manual tooth brush of claim 1, wherein the brush body defines an opening at one end, and the opening is in communication with the cavity, and wherein the tooth brush further comprises a cap that is engagable with the brush body to close the opening.

10. A method of tracking brushing time using a manual tooth brush comprising steps of:
providing a manual tooth brush including a brush timer and a tilt switch;
titling the manual tooth brush;
activating the tilt switch;
activating the brush timer;
brushing teeth with the tooth brush;
tracking a brushing time; and
deactivating the timer at an end of the brushing time.

11. The method defined in claim 10, further comprising steps of:
operatively engaging a Printed Circuit Board (PCB) with the brush timer and the tilt switch; and
programming the PCB to operate the brush timer.

12. The method defined in claim 11, further comprising a step of setting a predetermined brushing time in the programing of the PCB.

13. The method defined in claim 12, wherein the step of de-activating the timer occurs at the end of the predetermined brushing time.

14. The method of claim 10, wherein the step of tilting the manual tooth brush is accomplished by positioning a head of the tooth brush below a terminal end of a body extending outwardly from the head.

15. The method of claim 14, wherein the step of titling the manual tooth brush is accomplished by moving the head through an angle of from about 15 degrees up to about 25 degrees from a horizontally oriented axis.

16. The method of claim 10, wherein the step of activating the brush timer is accomplished by activating a ball tilt switch or a mercury tilt switch.

17. The method of claim 10, wherein the step of tracking the brushing time continues for up to about two minutes.

18. The method of claim 17, further comprising a step of issuing an alarm to a user of the manual tooth brush after a predetermined brushing time has ended.

19. The method of claim 18, wherein the step of issuing of an alarm comprises vibrating a portion of the tooth brush or generating an audible sound.

20. The method of claim 10, wherein the step of tracking the brushing time stops at around 2.5 minutes after the step of activating the brush timer.
